(19) United States
(12) Patent Application Publication
(10) Pub. No.: US 2021/0237336 A1
(43) Pub. Date: Aug. 5, 2021

(54) LOW SHRINK POLYESTER FILMS AND METHOD OF MAKING

(71) Applicant: 3M INNOVATIVE PROPERTIES COMPANY, St. Paul, MN (US)

(72) Inventors: JOHN P. PURCELL, OAKDALE, MN (US); JAMES B. SVACHA, SIMPSONVILLE, SC (US); STEPHEN A. JOHNSON, WOODBURY, MN (US); TIMOTHY J. LINDQUIST, WOODBURY, MN (US); GRANT F. TIEFENBRUCK, COTTAGE GROVE, MN (US); CHAD R. WOLD, STILLWATER, MN (US)

(21) Appl. No.: 16/066,326

(22) PCT Filed: Dec. 28, 2016
(86) PCT No.: PCT/US2016/068864

§ 371 Date: Jun. 27, 2018

Related U.S. Application Data
(60) Provisional application No. 62/272,417, filed on Dec. 29, 2015.

(51) Int. Cl. B29C 55/16; B32B 7/06; B32B 25/08; B32B 25/14; B32B 27/08; B32B 27/32; B32B 27/36; B32B 38/00; B29C 55/00; B29C 55/14; B29C 55/02; B29C 35/04

(52) U.S. Cl. CPC B29C 55/16; B29K 2067/00; B32B 25/08; B32B 25/14; B32B 27/08; B32B 27/32; B32B 27/36; B32B 38/0012; B29C 55/005; B29C 55/14; B29C 55/023; B29C 35/045; B32B 2250/24; B32B 2270/00; B32B 2307/518; B32B 2307/734; B32B 2307/748; B32B 7/06

(57) ABSTRACT

A method for making low shrink polyester films wherein the films are arranged in stacks, tentered, heat treated, and relaxed in unison. Also, polyester films produced by such method.

### FIELD

The present invention relates to oriented polyester films which are dimensionally stable (i.e., they exhibit low shrinkage when subjected to elevated temperatures) and methods for making such films.

### BACKGROUND

Polyester films are typically oriented to impart desired characteristics to the films (e.g., tendency to undergo thermally induced shrinkage, increase tensile strength, increase impact strength, etc.). Orientation is typically carried out through a heating and stretching regime. Films may be oriented in a single axial dimension (i.e., uni-axial orientation) such as either transverse direction or machine direction, or in two, typically perpendicular, axial dimensions (i.e., bi-axial orientation) such as in both the transverse direction and the machine direction.

Oriented films typically exhibit a tendency to shrink when subjected to substantial warming. It is known to treat oriented films with heat relaxation (i.e., heating to a temperature above the intended use temperature) to reduce the remaining latent shrink tendency for applications where a tendency to undergo thermally induced shrinkage is not wanted. Illustrative examples are disclosed in U.S. Pat. No. 3,632,726 (Knox et al.), U.S. Pat. No. 4,160,799 (Locy et al.), and U.S. Pat. No. 4,275,107 (Bartkus et al.) which disclose apparatus and processes for making dimensionally stable, flat plastic films wherein a web of film is heated to selectively shrink it while the web is supported by air impingement during heat relaxation.

In many applications, relatively thin polyester films are desired. However, heat relaxing such films is commonly known to lead to buckling of the film in cross web direction, impairing desired flat character of the films.

The need exists for thin caliper (e.g., about 127 microns (5 mils) or less, preferably 3 mil or less) polyester films that are highly flat and dimensionally stable (i.e., they exhibit low shrinkage when subjected to elevated temperatures) and methods for making such films.

### SUMMARY

The present invention provides polyester films which are dimensionally stable (i.e., they exhibit low shrinkage at elevated temperature). The invention also provides methods for making such films. The novel method of the invention can be used to produce polyester films exhibiting heretofore unattained and surprising combinations of low thickness, dimensional stability at high temperature, and high flatness.

The polyester films of the invention can exhibit relatively low thickness coupled with very low shrinkage and high flatness when exposed to high temperature. For instance, films of the invention may be about 127 microns (5 mils) or even thinner, while exhibiting less than 1% shrinkage at elevated temperatures (e.g., 150° C.) in both machine direction (i.e., parallel to the longitudinal axis of the web) and transverse or cross direction (i.e., perpendicular to the longitudinal axis of the web). The invention provides such polyester films as single films and in assemblies comprising a plurality of such films from which single films may be separated.

Briefly summarizing, the method of the invention comprises assembling polyester films in multilayer stacks referred to herein as treatment assemblies, then bi-axially orienting, heat setting, and heat relaxing the films in unison. After heat relaxation, individual films (which offer heretofore unattained combination of low thickness, high temperature dimensional stability, and high flatness) may be separated from the treatment assembly and used in desired applications.

### BRIEF DESCRIPTION OF DRAWING

The invention is further explained with reference to the drawing wherein:

FIG. 1 is a block diagram of an illustrative method of the invention;

FIG. 2 is a perspective view of a portion of an illustrative embodiment of a treatment assembly of the invention;

FIG. 3 is a cross sectional view of another illustrative embodiment of a treatment assembly of the invention; and

FIG. 4 is a cross sectional schematic view of another illustrative embodiment of a treatment assembly engaged with a portion of the apparatus in which it is subjected to cross direction tension.

These figures are not to scale and are intended to be merely illustrative and not limiting. The following reference numbers are used in the figures.

| Reference Number | Feature |
|---|---|
| 10, 30, 40 | Treatment assembly |
| 11, 34, 38 | Stack of layer packets |
| 12a, 12b, 12c, 12d | Layer packets |
| 14, 44b, 46b | Polyester film |
| 16 | First major surface of polyester film |
| 18 | Second major surface of polyester film |
| 20, 44a, 46a | Release layer |
| 22, 31 | First major surface of carrier |
| 24 | Second major surface of release layer |
| 26, 32, 42 | Carrier |
| 31 | Side of carrier |
| 33 | Second major surface of carrier |
| 34 | Stack of layer packets |
| 36a, 36b | Layer packets |
| 38 | Stack of layer packets |
| 40a, 40b | Layer packets |
| 48, 50 | Edge clip |
| 100 | Providing treatment assembly |
| 200 | Bi-axial orientation |
| 300 | Heat setting |
| 400 | Heat relaxation |
| 500 | Film separation |

### Key and Glossary

For the following defined terms, these definitions shall be applied, unless a different definition is given in the claims or elsewhere in this specification.

The term “polymer” will be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g., 1 to 5 includes 1, 1.5, 2, 2.75, 3, 3.80, 4, and 5). As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

### DETAILED DESCRIPTION OF ILLUSTRATIVE EMBODIMENTS

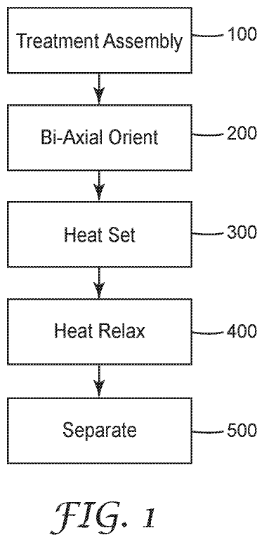

FIG. 1 is a schematic diagram of an illustrative embodiment of the method of the invention, the method comprising the steps of:

(a) providing 100 a treatment assembly comprising two or more polyester films;

(b) bi-axially orienting 200 the treatment assembly; then

(c) heat setting 300 the treatment assembly; and then

(d) heat relaxing 400 the treatment assembly; and

(e) optionally separating 500 individual polyester layers from the treatment assembly.

The method of the invention entails sequential treatment of the polyester films at a number of different temperature and dimensional tension or stress conditions. The temperature conditions are referred to herein as follows:

| | |
|---|---|
| T_{g} | Glass transition temperature of the polyester in |
| | the polyester film. |
| T_{Orient} | Orientation Temperature is the temperature of the |
| | polyester film during the bi-axial orientation. |
| T_{Use} | Use Temperature is the temperature at which the |
| | resultant polyester film could be used in |
| | intended application. |
| T_{Stable} | Stable Temperature is the highest temperature at |
| | which the resultant polyester film is |
| | dimensionally stable. |
| T_{Relax} | Relaxation Temperature is the temperature of the |
| | polyester film during heat relaxation. |
| T_{Set} | Set Temperature is the temperature of the polyester |
| | film during heat setting. |
| Tₘ | Melting Temperature is the temperature at which the |
| | polyester in the polyester film will melt. |

Relative to one another, the subject temperatures the method of the invention such as is shown in FIG. 1 are as follows:

T_{g}<T_{Orient}<T_{Use}≤T_{Stable}<T_{Relax}<T_{Set}<Tₘ.

It will be understood that these temperatures as referred to here are the temperatures to which the polyester layers are brought to during the subject processing operation and may be specific temperatures or ranges of temperatures having the indicated relationship. The principles which determine appropriate and preferred relationships between these temperatures are the same as which inform selection of operating temperatures for conventional orientation and dimensional stabilization of webs of single layers of polyester film.

As will be understood, the subject temperatures used in the method of the invention will be determined in part by the nature of the polyester film used, the maximum temperature (i.e., T_{Use}) of the intended application in which the polyester film is to be used and the minimum temperature (i.e., T_{Stable}) at which dimensional stability (i.e., low shrinkage) is lost as the polyester film begins to exhibit thermally induced shrinkage. Typically, the temperature (T_{Use}) of intended application and use will range from about 85° C. up to about 200° C. If dimensional stability is desired, a polyester film should be dimensionally stable at temperatures at least equal to the use temperature (i.e., have a T_{Stable}=T_{Use}). Often, it is preferred that the polyester film is dimensionally stable at temperatures somewhat above the use temperature, (i.e., have a T_{Stable}>T_{Use}). In typical embodiments, T_{Orient} is from 1° C. to 100° C. lower than T_{Use}.

Preferably, the method is carried out such that the temperature of the polyester film during heat relaxation (i.e., T_{Relax}) is from about 25 to about 35° C. more than the intended use temperature (T_{Use}). As will be understood, if the temperature used during heat relaxation is too close to the actual temperature at which the resultant film is used, the film may fail to exhibit desired dimensional stability during use. Preferably the temperature of the polyester film during relaxation (T_{Relax}) is from about 40° C. to about 100° C. lower than the temperature of the polyester film during heat setting (T_{Set}).

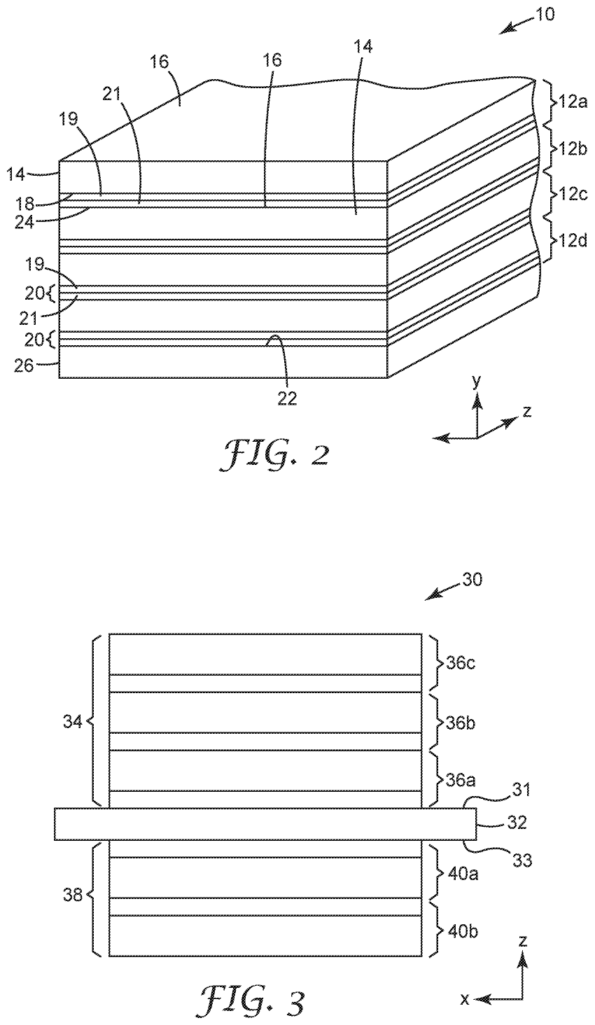

A portion of an illustrative embodiment of a treatment assembly of the invention is shown in FIG. 2 wherein treatment assembly 10 which comprises stack 11 of separable layer packets 12a-12d. Each layer packet comprises polyester film 14 having first and second major surfaces 16, 18 and release layer 20 having first and second major surfaces 22, 24 with first major surface 22 of release layer 20 being releasably attached to second major surface 18 of polyester film 14.

In this description the invention is described herein with reference to three mutually perpendicular dimensional axes of x, y, and z; the axes are shown in each Fig. to give orientation. As shown in FIG. 2 the x-axis refers to the axis of the treatment assembly from side-to-side. This dimension is sometimes referred to in the art as width, cross direction (i.e., CD), or transverse direction (i.e., TD)). The y-axis refers to the longitudinal axis of the treatment assembly (i.e., sometimes referred to as length or machine direction (i.e., MD)). The z-axis refers to the dimension of the treatment assembly through the plurality of layer packets (sometimes referred to as the height of the stack). When wound into roll form, the web is curved in its y-axis.

In the embodiment shown in FIG. 2, treatment assembly 10 also comprises optional carrier 26. In some embodiments, no carrier is used and the treatment assembly consists essentially of the stack of a plurality of layer packets.

FIG. 3 is a perspective view of another embodiment of a treatment assembly of the invention wherein treatment assembly 30 comprises optional carrier 32 having opposing sides 31, 33 with first stack 34 of layer packets 36a, 36b, each layer packet comprises releasably attached a polyester film having first and second major surfaces and a release layer having first and second major surfaces with the first major surface of the release layer being releasably attached to second major surface of the polyester film on side 31. In addition, treatment assembly 30 comprises second stack 38 on second side 33 of carrier 32.

### Providing a Treatment Assembly

In the method of the present invention, polyester films are handled and treated (i.e., oriented, heat set, and heat relaxed) in bundles referred to herein as treatment assemblies from which single polyester films may be separated. It has been found that manipulation of thin polyester films in this manner enables fabrication of oriented, dimensionally stable films of thinner thickness than was previously possible. Treatment assemblies used herein are typically in a continuous web format for the processing efficiencies and capabilities that can be achieved with that approach. The term “web” is used here to describe thin materials which are manufactured or processed in continuous, flexible strip form.

A treatment assembly comprises a plurality of layer packets stacked upon one another. Each layer packet comprises a polyester film having first and second major surfaces and a release layer having first and second major surfaces with the first major surface of the release layer being separably bonded to the second major surface of the polyester film. The layer packets are separably bonded in a stack such that the second major surface of the release layer of an overlying layer packet is separably bonded to the first major surface of the polyester film of an underlying layer packet.

Typically, it is preferred that within a treatment assembly the polyester films in respective layer packets within a stack are of similar width and length size (i.e., they have the same dimensions in the x-axis and y-axis) and stacked uniformly one over another (i.e., are aligned in the z-axis). The polyester films within a single treatment assembly may be of substantially similar thickness or of differing thickness.

The polyester films within a treatment assembly may be the same composition or different. It is typically preferred that the various polyester films within a treatment assembly have similar T_{g}. As will be understood, bi-axial orientation, heat setting, and heat relaxation will need to be carried out at temperature ranges sufficient high for the polyester layer having the higher T_{g}.

Polyester Films

Each layer packet comprises a semi-crystalline polyester film which is capable of being oriented, heat set, and heat relaxed. The polyester is configured into film form having first and second major surfaces by known technique, such as casting, extrusion, and the like.

Selection of the polyester is dependent in part upon the intended end use application and properties desired therefor. The polyester constituting the polyester film is a polymer obtained by a condensation polymerization of a diol and a dicarboxylic acid. The diol is typified by ethylene glycol, trimethylene glycol, tetramethylene glycol, cyclohexanedimethanol, combinations thereof. The dicarboxylic acid is typified by terephthalic acid, isophthalic acid, phthalic acid, naphthalene dicarboxylic acid, adipic acid, sebacic acid, and combinations thereof. Specifically, polymethylene terephthalate, polyethylene terephthalate, polytetramethylene terephthalate, polyethylene-p-oxybenzoate, poly-1,4-cyclohexanedimethalene tere-phthalate, and polyethylene-2,6-naphthalate are given by way of example as such polyesters. These polyesters may be either homopolymers or copolymers. Copolymer structural units may for example comprise diol units, such as diethylene glycol, neopenthal glycol, and polyalkaline glycol, or dicarboxylic acid units, such as adipic acid, sebacic acid, phthalic acid, isophthalic acid, and 2,6-naphthalene dicarboxylic acid.

From considerations such as mechanical strength, heat resistance, chemical resistance, and durability, polyethylene terephthalate (sometimes referred to as “PET”) and polyethylene-2,6-naphthalate (sometimes referred to as “PEN”) are often preferred for many applications. Among these two, polyethylene terephthalate is often the more preferable due to its lower cost.

The polyester may be used alone in the polyester layer, or as a copolymer with another polyester, or in a mixture of two or more kinds of polyesters. It is typically preferably used alone, from the view point of mechanical properties and heat-resistance. If present, other ingredient(s) in a copolymer or a mixture are preferably no more than 10 mol % and, more preferably no more than 5 mol % based on the number of moles for the repetitive structural units. The copolymerization ingredient may include a diol ingredient such as diethylene glycol, neopentyl glycol, and polyalkylene glycol, and/or a dicarboxylic acid ingredient such as adipic acid, sebacic acid, phthalic acid, isophthalic acid, terephthalic acid, and 5-sodium sulfoisophthalic acid.

Typically, the polyester film comprises one or more polyesters having a T_{g} and a Tₘ wherein the T_{g} is below the desired T_{Use}, and the Tₘ is sufficiently high that axial orientation at T_{Orient}, heat setting at T_{Set}, and heat relaxation at T_{Relax} as described herein can be carried out wherein:

T_{Orient}<T_{Relax}<T_{Set}<Tₘ.

In the embodiment shown in FIG. 2, the treatment assembly comprises four separable layer packets 12a, 12b, 12c, 12d. In typical embodiments, the treatment assembly comprises from 2 to 20 separable layer packets. Treatment assemblies comprising more layer packets may be used in accordance with the invention; as will be understood, increasing the number of layer packets in a treatment assembly tends to increase the mechanical forces necessary to orient, transport, and handle the treatment assembly as well as correspondingly impact the time and heating intensity demands necessary to raise the temperature of the treatment assembly through the progressive steps of the method of the invention.

Typically it is preferred that each film is flat and of substantially uniform thickness (i.e., substantially uniform dimension in its z-axis throughout its entire width, that is from side-to-side (i.e., the x-axis), and length, that is end-to-end (i.e., the y-axis)).

As known in the art, the polyester films will thin substantially in accordance with the stretch ratios applied during bi-axial orientation. Accordingly, the initial thickness of the polyester films when the treatment assembly is formed is selected in large part upon the desired thickness of the resultant bi-axially oriented, heat set, heat relaxed polyester films. Depending upon the stretch ratios used, the initial thickness is often from about 10 to about 20 times that of the final thickness.

Advantages of the present invention include that by processing polyester films within a treatment assembly as described herein, resultant polyester films exhibiting surprising dimensional stability at elevated temperatures may be produced at heretofore unavailable surprisingly thin thicknesses.

Release Layers

The release layers should provide desired adhesion to adjacent polyester layers in the treatment assembly throughout the steps of the method of the invention. In some embodiments, the release layers provide a bond strength to the polyester films of from about 2 to about 40 g/cm-width (5 to 100 g/in-width).

The release layer should be compatible with the polyester (i.e., not react undesirably therewith, stain, or degrade the polyester), throughout the process conditions (i.e., elevated temperatures, stretching, winding, etc.). The release layer should be able capable of stretching, preferably yielding smoothly during axial orientation, substantially without any tendency to elastically recover during heat setting and heat relaxation.

The release layer should be such that after use in the method of the invention, in particular after orientation (which will impart some thinning or necking down of the thickness of the release layer), heat setting, and heat relaxation, the release layer exhibits sufficient body to permit it to be effectively separated from the polyester layer to permit the polyester layer to be used as desired. Preferably the release layer and polyester film are compatible such upon removal of the release layer from the face of the polyester film no residue is left on the polyester film and no undesired degradation to the surface of the polyester film is imparted.

Typically, the desired average thickness of the release layers after orientation of the polyester films is from about 2 to about 25 microns (0.1 to 1.0 mil), preferably from about 7.5 to about 18 microns (0.3 to 0.7 mil). Depending upon the stretch ratios used, the initial thickness is often from about 10 to about 20 times that of the final thickness. Typically, each release layer has substantially uniform thickness from side-to-side (i.e., the x-axis) and end-to-end (i.e., the y-axis).

Suitable release layers may be readily selected by those skilled in the art. Illustrative examples include polymeric materials selected from the group consisting of polyolefins (e.g., polymethylene, polyethylene, polypropylene, copolymers of polyethylene and polypropylene, etc.), styrene/rubber block copolymers (e.g., block copolymers of styrene and polystyrene with polybutadiene, polyisoprene, or hydrogenated equivalents), ethylene alpha olefin copolymers, olefin block copolymers, and blends of one or more such materials. The layers disclosed in US Patent Appln. Publn. No. 2014/0065397 (Johnson et al.) as “interlayer (C)” are suitable for use as release layers in treatment assemblies of the present invention.

Release layers may be monolayer or multilayer. For instance, release layers may be fabricated in bi-layer form with differing composition so as to improve desired properties. For instance, in some embodiments one of the layers within a multilayer release layer is formulated to impart increased body and strength to the release layer such that separation from the polyester layers is more easily accomplished. In some embodiments, one of the layers within a bi-layer release layer is formulated to impart relatively higher adhesion to adjacent polyester film in the treatment assembly than the level of adhesion provided by the other layer within the bi-layer release layer. For instance, referring to FIG. 2, release layers 20 are of a bi-layer configuration, comprising upper layer 19 releasably bonded to second major surface 18 of overlying polyester layer 14 and lower layer 21 releasably bonded to first major surface 16 of underlying polyester layer 14.

Assembly

Alternating selected polyester films and release layers are arranged and configured into a stack to form a treatment assembly. Suitable methods and techniques for forming the constituent films and layers, and arranging and configuring them into desired multilayer stacks will be well known to those skilled in the art. Illustrative examples include co-extrusion, lamination of previously formed films and layers (e.g., cast, extruded layers, etc.). Co-extrusion methods will typically be preferred, particularly for embodiments of the invention utilizing relatively thin polyester films and release layers.

The polyester films in a treatment assembly may be the same or different in composition. The polyester films in a treatment assembly may have the same or different in thickness (i.e., z-axis dimension).

The release layers in a treatment assembly may be the same or different in composition. The release layers in a treatment assembly may have the same or different in thickness (i.e., z-axis dimension).

It is typically preferred that the stack be at least about 50 microns (2 mils) thick (i.e., z-axis dimension). At thinner dimensions, there is greater tendency for the polyester layers to undergo corrugation during heat relaxation. Thicker treatment assemblies may be used in accordance with the invention, though as will be understood, use of thicker treatment assemblies tends to increase the mechanical forces necessary to orient, transport, and handle the treatment assembly as well as correspondingly impact the time and heating intensity demands necessary to raise the temperature of the treatment assembly through the progressive steps of the method of the invention. Thus, while there is essentially no technical upper limit to the number of layer packets, or thickness of polyester layers therein, from which a treatment assembly may be fabricated, there may be practical limit imposed by the processing demands necessary to orient, transport, and handle the treatment assembly in accordance with the method of the present invention.

In some embodiments, as shown in FIG. 2, treatment assembly 10 further comprises optional carrier 26 on which stack 11 is supported. The carrier facilitates handling of the treatment assembly as the method of the invention is carried out.

### Axial Orientation

As shown in FIG. 1, the treatment assembly (including its constituent polyester films) is bi-axially oriented in station 200.

Well known processes and apparatuses for bi-axially orienting polyester films may be used in the method of the invention. Typically bi-axial orientation is carried out either simultaneously (i.e., stretching in both x-axis and y-axis at the same time) or sequentially (i.e., stretching first in one of the x-axis or y-axis and then stretching in the other axis). Illustrative examples of apparatus that may be used for treating treatment assemblies of the invention to carry out desired orienting, heat setting, and heat relaxing of the constituent polyester layers are disclosed in U.S. Pat. No. 2,779,684 (Alles), U.S. Pat. No. 2,823,421 (Scarlett), U.S. Pat. No. 4,261,944 (Hufnagel et al.), and U.S. Pat. No. 5,885,501, each of which is incorporated by reference in its entirety. While conventionally single polyester films are oriented, heat set, and heat relaxed, in the present invention the apparatus used must be capable of handling treatment assemblies as described herein which comprise two or more polyester layers as well as the release layers and optional carrier, if used.

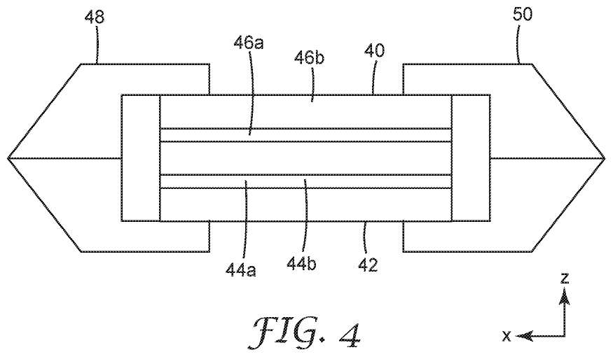

An illustrative configuration is shown in FIG. 4 where treatment assembly 40 comprising carrier 42 and a first layer packet of release layer 44a and polyester 44b and a second layer packet of release layer 46a and polyester 46b held by clips 48, 50. During methods employing simultaneous orientation, assembly 40 will be engaged with a series of clips 48, 50 to impart both transverse and machine direction tension and stretching. During methods employing sequential orientation, assembly 40 will be engaged with a series of clips 48, 50 during the transverse orientation phase whereas during the machine direction orientation phase typically clips 48, 50 are release and machine direction tension and stretching is imparted by rollers.

Bi-axially orienting the polyester films is carried out by heating the treatment assembly such that the polyester films reach a temperature of T_{Orient} wherein T_{Orient} is above the T_{g} of the polyester film, and biaxially stretching the treatment assembly while the polyester layers are at a temperature of at least T_{Orient}. T_{Orient} is typically at least 5° C. or more higher than T_{g} to avoid web breaks and obtain smoother, more uniform stretching throughout the polyester layers. Typically, Torrent is not more than 10° C. higher than T_{g}.

Although the force required to stretch the polyester layers tends to decline at relatively higher temperatures, it is typically preferred to carry out axial orientation under temperatures that are as low as possible. Even though orientation under such conditions requires more force, the polyester film achieves higher crystallinity and stress hardening during orientation.

If bi-axial orienting is carried out sequentially, the film may be heated so as to be at a first orientation temperature (i.e., T_{Orient1}) during the orientation in the first axial direction (e.g., one of the transverse or machine direction) and a second orientation temperature (i.e., T_{Orient2}) during the orientation in the second axial orientation (e.g., the other of the transverse or machine direction) wherein T_{Orient1} and T_{Orient2}, which may be the same or different, are each above the T_{g} of the film and below T_{Set} used.

The stretch ratio will be determined in part by the intended end use application of the polyester film and desired properties. Typically, the stretch ratio will be about 3:1 to 5:1 in each of the transverse direction (i.e., x-axis) and the longitudinal axis (i.e., y-axis) though higher ratios may be used if desired.

The length of time necessary to carry out axial orientation will depend in part upon the temperature in the orienter, force capability of the orienter, and size and bulk of the treatment assembly. Treatment assemblies comprising more layer packets, or layer packets comprising thicker polyester films or thicker release layers, will tend to require longer or more intense heating to warm to the desired orientation temperature than will treatment assemblies comprising relatively fewer layer packets or layer packets comprising thinner polyester films and thinner release layers.

The treatment assembly in its form after bi-axial orientation but before heat setting is referred to herein as an “oriented assembly”. After bi-axial orientation, the oriented assembly, comprising a plurality of layer packets in which the polyester films are bi-axially oriented (and the release layers are now stretched), is then passed to the step of heat setting.

### Heat Setting

Heat setting is typically carried out directly after bi-axial orientation and is preferably done in-line.

Heat setting the oriented polyester films is carried out by heating the oriented assembly (e.g., in an oven) such that the polyester films reach a temperature T_{Set} wherein T_{Set} is (1) above T_{Orient} in the case of simultaneous bi-axial orientation, or above both T_{Orient1} and T_{Orient2} in the case of sequential bi-axial orientation, and (2) below Tₘ (e.g., typically preferably from about 20° C. to about 60° C. below) while maintaining the desired dimensions (i.e., the oriented assembly is held in lengthwise and crossweb tension such as is shown in FIG. 4 so as to maintain its x-axis and y-axis dimensions) so as to raise the crystallinity of the polyester component while resisting change in dimension in the x-axis and y-axis.

The length of time necessary to carry out heat setting will depend in part upon the oven temperature, the size and bulk of the treatment assembly. Treatment assemblies comprising more layer packets, or layer packets comprising thicker polyester films or thicker release layers, will tend to require longer or more intense heating to warm to the desired temperature (i.e., T_{Set}) than will treatment assemblies comprising relatively fewer layer packets or layer packets comprising thinner polyester films or thinner release layers. Typically it is preferred that the subject polyester films have a residence time of at least 5 seconds or more after achieving the desired temperature (T_{Set}).

The treatment assembly in its form after heat setting but before heat relaxation is sometimes referred to herein as a “heat set assembly”. After heat setting, the heat set assembly, comprising a plurality of now bi-axially oriented, heat set polyester films, is then passed to the step of heat relaxing.

### Heat Relaxation

Heat relaxing may be carried out directly after heat setting (e.g., in an in-line manner) or the heat set assembly maybe stored and then heat relaxed at another time, another location, or both as desired.

Heat relaxing the treatment assembly is carried out by heating the heat set assembly such that the polyester films reach a temperature T_{Relax} wherein T_{Relax} is below T_{Set} and above T_{Orient} while being substantially unrestrained in the x and y axial dimensions. During heat relaxation, the treatment assembly is typically subjected to a machine direction tension of about 1.4 megapascals (200) psi or less, preferably about 0.7 megapascal (100 psi) or less, and more preferably about 0.3 megapascal (50 psi) or less. Typically the treatment assembly is unrestrained in the transverse direction during heat relaxation with the clips or other means used to apply transverse direction tension during orientation and heat setting having been released.

T_{Relax} is typically from about 25 to about 35° C. above the intended use temperature (Tᵤ).

The length of time necessary to carry out heat relaxation step will depend in part upon the oven temperature, the size and bulk of the treatment assembly. Treatment assemblies comprising more layer packets, or layer packets comprising thicker polyester films or thicker release layers, will tend to require longer or more intense heating to warm to the desired temperature (i.e., T_{Relax}) than will treatment assemblies comprising relatively fewer layer packets or layer packets comprising thinner polyester films or thinner release layers.

Those skilled in the art will be able to select suitable apparatus for carrying out heat relaxation of the polyester layers in the treatment assembly. Illustrative examples include air floatation ovens, hot cans with air cushion apparatus, and the like. If desired, heat relaxation may be carried out with conventional hot cans in which the treatment assembly comes into direct contact with the heating device, though it is likely that such methods will result in scratching or deformation of at least the member of the treatment assembly which is in direct contact.

After relaxation has occurred (e.g., by holding the assembly at T_{Relax} for a time (e.g., while it is substantially unrestrained), the treatment assembly is cooled and typically wound into roll form before further processing and use.

The treatment assembly, in its form after heat relaxation but before separation of individual polyester layers therefrom is sometimes referred to herein as a “heat relaxed assembly”. After the relaxation step, the heat relaxed assembly, comprising a plurality of now biaxially oriented, heat set, heat relaxed polyester films and interleaved stretched release layers, is then passed on for further use, such as separation and use of individual dimensionally stable polyester layers in desired applications, shipment to another location, transfer to another party for use, etc.

Separation

The individual polyester layers may be separated from the heat relaxed assembly directly after cooling, or separation may be carried out at another time, another location, or both.

The constituent release layer and polyester film of the layer packets are selected such that, after orientation, heat setting, and heat relaxation, they are separable, that is they may be successively delaminated in continuous sheet form to yield single polyester films.

As desired, the heat relaxed assembly may be converted before separation of individual polyester layers therefrom, such as by (1) subdividing or slitting in the y-axis to form one or more narrower webs comprising a plurality of polyester films and release layers, or (2) cutting in the x-axis to form shorter one or more shorter webs or stacks comprising a plurality of polyester films and release layers, or (3) both subdividing and cutting in such manner.

### Use of Resultant Product

Films of the invention exhibit surprising dimensional stability, particularly at heretofore unattainable low calipers. For instance, the method of the invention can be used to manufacture polyester films that exhibit shrinkage at 150° C., in both the transverse direction and the machine direction, of less than about 1%, preferably less than about 0.5%, and in some instances less than about 0.2%. The invention provides polyester films exhibiting such high dimensional stability which in some embodiments have an average thickness of about 127 microns (5 mils) or less, in other embodiments an average thickness of about 76 microns (3 mils) or less, in other embodiments an average thickness of about 51 microns (2 mils) or less, in other embodiments an average thickness of about 25 microns (1 mil) or less, and in some embodiments an average thickness of even about 13 microns (0.5 mil) or less.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. The complete disclosure of all patents, patent documents, and publications cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A method for making dimensionally stable polyester films comprising the steps of:
(a) providing a treatment assembly comprising a plurality of layer packets, each layer packet comprising a polyester film, the polyester film comprising one or more semicrystalline polyesters having a T_{g} and a Tₘ, having first and second major surfaces and a release layer having first and second major surfaces, the first major surface of the release layer being attached to the second major surface of the polyester film, wherein the layer packets are arranged in a stack such that the second major surface of the release layer of an overlying layer packet is separably attached to the first major surface of the polyester film of an underlying layer packet;
(b) bi-axially orienting the polyester films by heating the treatment assembly such that the polyester films reach a temperature of at least T_{Orient} wherein T_{Orient} is above the T_{g} of the polyester film and biaxially stretching the treatment assembly while the layer packets are at a temperature of at least T_{Orient} to yield an oriented assembly; then
(c) heat setting the polyester films by heating the oriented treatment assembly to a temperature T_{Set} wherein T_{Set} is above T_{Orient} and below Tₘ while maintaining the orienting configuration and dimensions so as to raise the crystallinity of the polyester component to yield a heat set assembly; and then
(d) heat relaxing the heat set treatment assembly by heating to a temperature T_{Relax} wherein T_{Relax} is below T_{Set} and above T_{Orient} while being substantially unrestrained in the x and y axial dimensions to yield a heat relaxed assembly.

2. The method of claim 1 wherein the treatment assembly comprises from 2 to 20 layer packets.

3. The method of claim 1 wherein the treatment assembly comprises a carrier.

4. The method of claim 1 wherein the average thickness of each polyester film in each layer packet in the heat relaxed assembly is about 127 microns (5 mils) or less.

5-10. (canceled)

11. The method of claim 1 wherein the polyester films comprise polymeric material obtained by a condensation polymerization of a diol and a dicarboxylic acid.

12. The method of claim 11 wherein the polyester films comprise one or more of the following materials: polymethylene terephthalate, polyethylene terephthalate, polytetramethylene terephthalate, polyethylene-p-oxybenzoate, poly-1,4-cyclohexanedimethylene tere-phthalate, and polyethylene-2, 6-naphthalate.

13. The method of claim 11 wherein the diol is selected from the group consisting of ethylene glycol, trimethylene glycol, tetramethylene glycol, cyclohexanedimethanol, and combinations thereof.

14. The method of claim 11 wherein the dicarboxylic acid is selected from the group consisting of terephthalic acid, isophthalic acid, phthalic acid, naphthalene dicarboxylic acid, adipic acid, sebacic acid, and combinations thereof.

15. The method of 11 wherein the polyester films comprise polyethylene napthalate or polyethylene terephthalate.

16. The method of claim 1 wherein the average thickness of the release layers is from about 5 to about 25 microns (0.2 to 1.0 mil), preferably from about 7.5 to about 18 microns (0.3 to 0.7 mil).

17. The method of claim 1 wherein the release layers provide a bond strength to the polyester films of from about 2 to about 40 g/cm-width (5 to 100 g/in-width).

18. The method of claim 1 wherein the release layers comprise polymeric materials selected from the group consisting of polyolefins, styrene/rubber block copolymers, ethylene alpha olefin copolymers, olefin block copolymers, and blends of one or more such materials.

19. The method of claim 1 wherein at least some release layers are bi-layer.

20. The method of claim 1 wherein at least some layer packets comprise a release layer which exhibits stronger adhesion to the polyester film in the layer packet than the release layer does to an underlying polyester film.

21. The method of claim 1 wherein bi-axially orienting the polyester films is carried out by simultaneous bi-axial orientation.

22. The method of claim 18 wherein bi-axially orienting the polyester films comprises the sequential orientation steps of:
(b1) orienting the polyester films in a first axial direction by heating the treatment assembly such that the polyester films reach a temperature of at least T_{Orient1} wherein T_{Orient1} is above the T_{g} of the polyester film and then stretching the treatment assembly in the first axial direction while the layer packets are at a temperature of at least T_{Orient1} and then
(b2) orienting the polyester films in a second axial direction by heating the treatment assembly such that the polyester films reach a temperature of at least T_{Orient2} wherein T_{Orient2} is above the T_{g} of the polyester film and stretching the treatment assembly in the second axial direction while the layer packets are at least T_{Orient2};
wherein T_{Orient1} and T_{Orient2} may be the same or different.

23. The method of claim 1 wherein orienting the polyester films in the first axial direction comprises stretching the treatment assembly by a ratio of about 3 to about 5:1 or more in the first axial direction.

24. The method of claim 1 wherein orienting the polyester films in the second axial direction comprises stretching the treatment assembly by a ratio of about 3 to about 5:1 or more in the second axial direction.

25. The method of claim 1 wherein the first axial direction and second axial direction are substantially perpendicular.

26. The method of claim 1 wherein the heat relaxing is carried out in an air floatation oven or hot can with air impingement.

27-42. (canceled)
